(19) United States
(12) Patent Application Publication
(10) Pub. No.: US 2008/0281854 A1
(43) Pub. Date: Nov. 13, 2008

(54) Opt-out community network based on preseeded data

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/800,884

(22) Filed: May 7, 2007

(51) Int. Cl. G06F 17/00

(52) U.S. Cl. 707/102

(57) ABSTRACT

A method, apparatus, and system of an opt-out community network based on preseeded data are disclosed. In one embodiment, a method includes procuring preseeded data, providing categories of the preseeded data, generating a community network of user profiles based on the preseeded data, each user profile associated with a specific geographic location, automatically generating, within the community network, groups of user profiles, each group of user profiles based on at least one of the categories of preseeded data, generating a display view to include a three-dimensional map view embodied by the community network, at least a portion of the user profiles represented at locations in three-dimensional map view corresponding with the specific geographic locations of the portion of the user profiles, and enabling a communication, via a communication mode, associated with a first user profile and a second user profile.

### FIELD OF TECHNOLOGY

This disclosure relates generally to the technical fields of communications and, in one example embodiment, to a method, apparatus, and system of an opt-out community network based on preseeded data.

### BACKGROUND

A community network may be a collection of individuals, organizations, businesses, etc. The community network may encourage relationships based on shared interests (e.g., professional, recreational, social, academic, political, geographic, cultural, etc.).

Development of the community network, however, may be a slow process. Individuals may need to sign up in advance to become members. To join the community network, an individual may expend time and effort to input personal information such as an address, photos, and interests. The individual may also need to individually enroll in groups of interest and may need to input additional information pertinent to enrollment in each group.

In some cases, membership in the community network may be by invitation only. For example, a registered member of the community network may have to issue an invitation to the individual before the individual is eligible for membership. The registered member may decide against issuing an invitation because the individual does not meet basic criteria and/or have enough common interests to qualify for membership. Furthermore, even if an invitation is extended, the individual may not have an interest in joining.

As such, it may take a long time for the community network to include enough members to reach critical mass (e.g., have enough members to attract new members and function fairly comprehensively as a community network).

### SUMMARY

A method, apparatus and system of an opt-out community network based on preseeded data are disclosed. In one aspect, a method includes procuring preseeded data (e.g., from a public source), providing categories of the preseeded data (e.g., geographic region, age, age range, interest, religion, gender, occupation, ethnicity, location of a residence, location of a business, marital status, ownership status, language, mobility, income, life cycle, socioeconomic status, and/or lifestyle, etc.), generating a community network of user profiles based on the preseeded data, each user profile associated with a specific geographic location (e.g., each specific geographic location of each user profile of the group of user profiles may be associated with the first geographic region), automatically generating, within the community network, groups of user profiles, each group of user profiles based on at least one category of the preseeded data, generating a display view to include a three-dimensional map view embodied by the community network, at least a portion of the user profiles represented at locations in the three-dimensional map view corresponding with the specific geographic locations of the portion of the user profiles, and enabling a communication, via a communication mode (e.g., the communication mode may be selected from a group consisting of an email, an instant message, a physical mail, an audio communication, a video communication, and/or a multimedia communication, etc.), associated with a first user profile and a second user profile.

In addition, the method may include determining a first geographic region, and automatically generating, in the display view, a group of user profiles. The method may also include selecting at least one category of the preseeded data and automatically generating, in the display view, a group of user profiles, in which each specific geographic location of the user profiles of the group of user profiles is associated with the first geographic region and each user profile is associated with the category of the preseeded data.

Furthermore, the method may include selecting the first geographic region from a group comprising a neighborhood associated with a street address, a city, a county, a state, and/or a country, etc. The method may also include enabling formation of a group based on at least one of the categories of the preseeded data. In addition, the method may include simultaneously generating in the map wiki profiles associated with specific geographic locations.

The method may further include permitting a user to edit information of any wiki profile until a particular wiki profile is claimed, enabling a registered user to claim a user profile, enabling a claimant to segregate information of the claimed user profile and an associated wiki profile associated with the specific geographic location of the claimed user profile, and enabling the claimant to control which portions of the segregated information are viewable and to determine which parties are permitted to view a particular portion of the segregated information. Moreover, the method may include permitting a user to opt-out of a claim associated with a user profile.

In another aspect, a system includes a geo-spatial environment, a data procurement module of the geo-spatial environment to procure preseeded data (e.g., the preseeded data may be procured from a public source), a category module of the geo-spatial environment to provide categories of the preseeded data (e.g., geographic range, age, age range, interest, religion, gender, occupation, ethnicity, location of a residence, location of a business, marital status, ownership status, language, mobility, income, life cycle, socioeconomic status, and/or lifestyle, etc.), a community network module of the geo-spatial environment to include user profiles, each user profile to include at least a portion of the preseeded data, a map module of the geo-spatial environment to include map data of specific geographic locations associated with each user profile, a group module of the geo-spatial environment to generate groups of user profiles, each group based on at least one of the categories of the preseeded data, a display module of the geo-spatial environment to generate a display view of a three-dimensional map view embodied by a community network, at least a portion of the user profiles represented at locations in the three-dimensional map view corresponding with the specific geographic locations of the portion of the user profiles, and a communication module of the geo-spatial environment to generate a communication via a communication mode (e.g., the communication mode may include an email, an instant message, a physical mail, an audio communication, a video communication, and/or a multimedia communication, etc.) associated with at least one user profile.

The system may also include a visualization module of the geo-spatial environment to determine a geographic region, to select at least one category, and to automatically generate, in the display view, a group of user profiles, in which each specific geographic location of each user profile of the group of user profiles may be associated with the geographic region (e.g., the geographic region may be selected from a group comprising a neighborhood associated with a street address, a city, a county, a state, and/or a country, etc.) of the geographic regions and in which each user profile is associated with the category of the preseeded data.

The system may further include a group formation module of the geo-spatial environment to enable formation of a group of user profiles based on at least one category of the preseeded data. In addition, the system may include a claim module of the geo-spatial environment to enable claiming of a user profile. The system may also include an opt-out module of the geo-spatial environment to enable opting out of a claim associated with a user profile. The system may also include a wiki profile module to generate a wiki profile associated with at least one representation of a user profile. In addition, the system may include an append module to generate, with the wiki profile, content associated with the wiki profile.

In yet another aspect, a geo-spatial environment includes a first instruction set to enable a community network, to include a preseeded data database to include user profiles and categories of the preseeded data and a map database to include map data, in which the community network is associated with specific geographic locations identifiable in the map data, a second instruction set integrated with the first instruction set to generate groups of user profiles, each group based on at least one category of the preseeded data, and a third instruction set integrated with the first instruction set and the second instruction set to generate a communication associated with at least one user profile.

The geo-spatial environment may further include a fourth instruction set to display, in a three-dimensional map, a representation of each user profile of a group of user profiles, in which the specific geographic location of each user profile corresponds with a location in the three-dimensional map. In addition, the geo-spatial environment may include a fifth instruction set to select at least one category of preseeded data, and to display in a three-dimensional map, a representation of each user profile in which the specific geographic location of each user profile corresponds with a location in the three-dimensional map and each user profile is associated with the category of preseeded data.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with a map data and users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a schematic representation of data communication, according to one embodiment.

FIG. 5 is a user interface view displaying preseeded data associated with a user profile, according to one embodiment.

FIG. 6 is a user interface view of claiming the user profile, according to one embodiment.

FIG. 7 is a user interface view of opting out from the user profile, according to one embodiment.

FIG. 8 is a user interface view displaying groups associated with a user, according to one embodiment.

FIG. 9 is a user interface view of searching for neighborhood groups in the geo-spatial environment, according to one embodiment.

FIG. 10 is a user interface view of the visualization module of FIG. 3, according to one embodiment.

FIG. 11 is a user interface view of the group formation module of FIG. 3, according to one embodiment.

FIG. 12 is a table view of information associated with a user profile in the geo-spatial environment, according to one embodiment.

FIG. 13 is a diagrammatic system view of a data processing system in which any of the embodiments disclosed herein may be performed, according to one embodiment.

FIG. 14A is a process flow of forming a community network based on preseeded data, according to one embodiment.

FIG. 14B is a continuation of the process flow of FIG. 14A illustrating additional processes, according to one embodiment.

FIG. 14C is a continuation of the process flow of FIG. 14B illustrating additional processes, according to one embodiment.

Other features of the present embodiments will be apparent from the accompanying drawings and from the detailed description that follows.

### DETAILED DESCRIPTION

A method, apparatus and system of an opt-out community network based on preseeded data are disclosed. In the following description, for the purposes of explanation, numerous specific details are set forth in order to provide a thorough understanding of the various embodiments. It will be evident, however to one skilled in the art that the various embodiments may be practiced without these specific details.

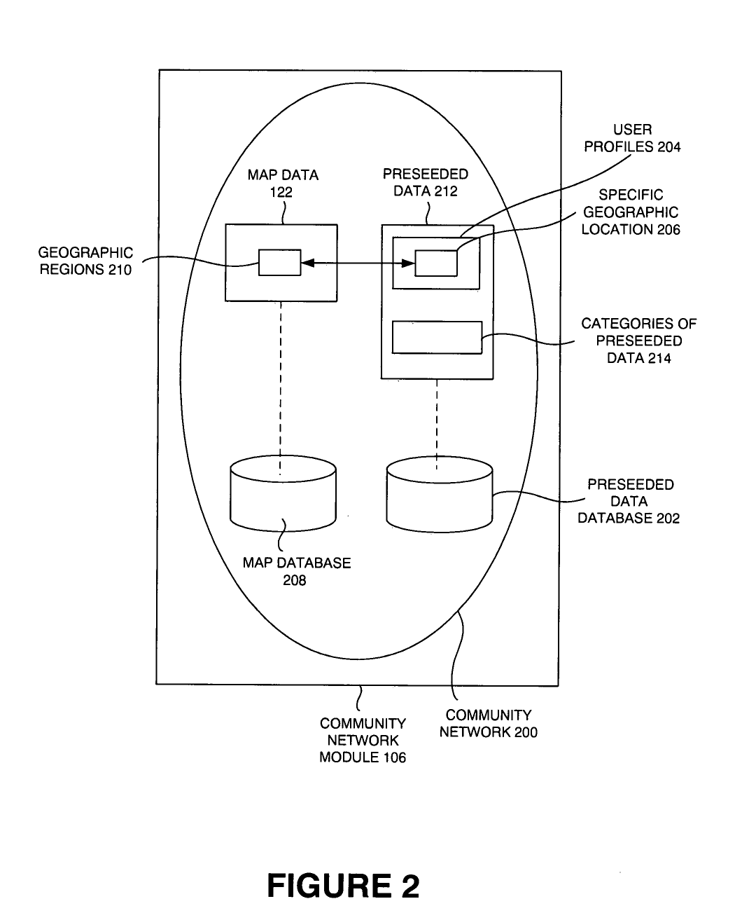

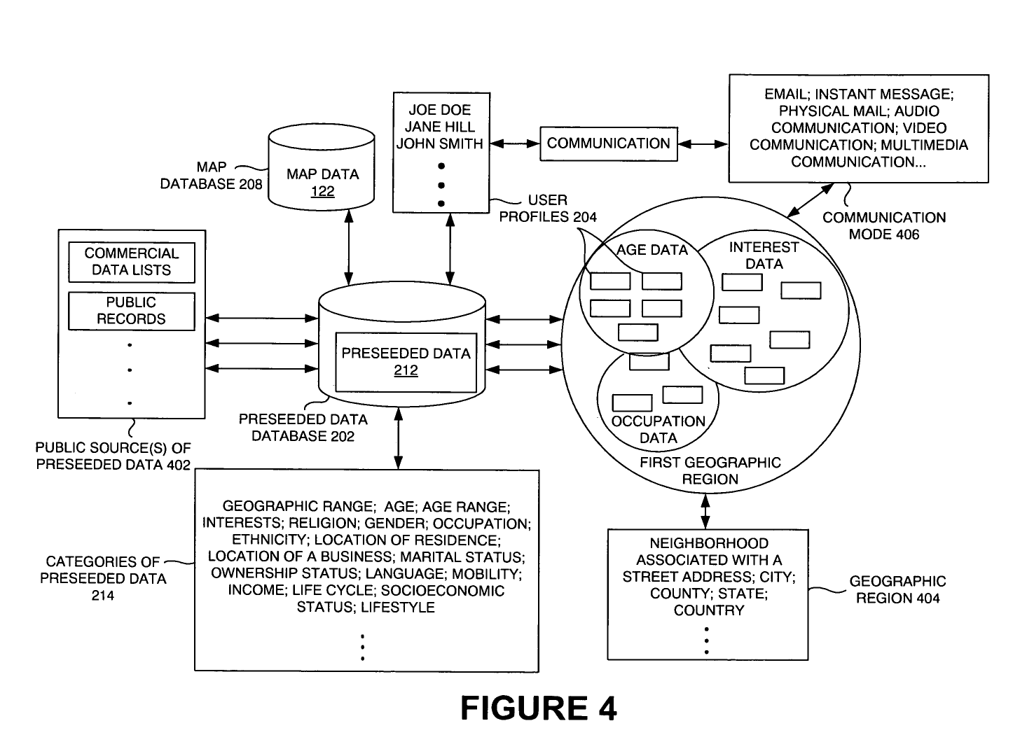

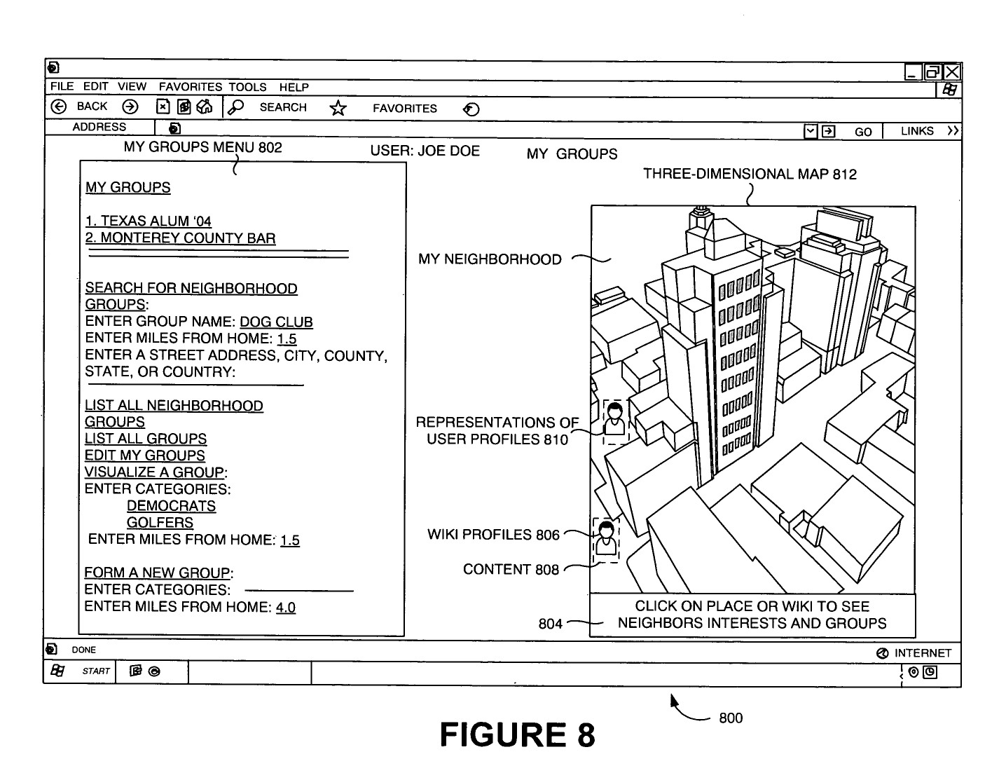

In one embodiment, a method includes procuring preseeded data (e.g., the preseeded data 212 of FIG. 2), providing categories of the preseeded data (e.g., the categories of preseeded data 214 of FIG. 2), and generating a community network (e.g., the community network 200 of FIG. 2) of user profiles (e.g., the user profiles 204 of FIG. 2) based on the preseeded data 212. Each user profile 204 is associated with a specific geographic location (e.g., the specific geographic location 206 of FIG. 2). The method also includes automatically generating, within the community network 200, groups of user profiles 204 (e.g., each group of user profiles 204 based on at least one category of preseeded data 214), generating a display view to include a three-dimensional map view embodied by the community network 200 (e.g., as illustrated in FIG. 8-11). At least a portion of the user profiles 204 is represented at locations in the three-dimensional map view corresponding with the specific geographic locations 206 of the portion of the user profiles 204. The method further includes enabling a communication via a communication mode (e.g., the communication mode 406 of FIG. 4), associated with a first user profile 204 and a second user profile 204.

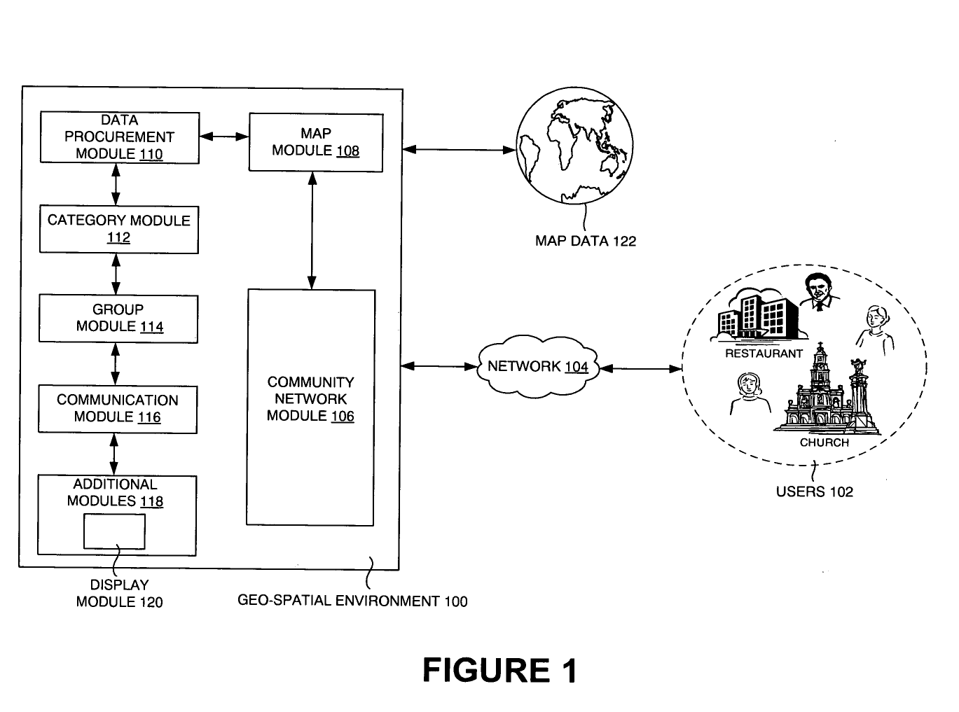

In another embodiment, a system includes a geo-spatial environment (e.g., the geo-spatial environment 100 of FIG. 1), a data procurement module (e.g., the data procurement module 110 of FIG. 1) of the geo-spatial environment 100 to procure preseeded data (e.g., the preseeded data 212 of FIG. 2), a category module (e.g., the category module 112 of FIG. 1) of the geo-spatial environment 100 to provide categories of the preseeded data (e.g., the categories of preseeded data 214 of FIG. 2), and a community network module (e.g., the community network module 106 of FIG. 1) of the geo-spatial environment 100 to include user profiles (e.g., the user profiles 204 of FIG. 2). Each user profile 204 includes at least a portion of the preseeded data 212. The system also includes a map module (e.g., the map module 108 of FIG. 1) of the geo-spatial environment 100 to include map data (e.g., the map data 122 of FIG. 1) of specific geographic locations (e.g., the specific geographic location 206 of FIG. 2) associated with each user profile 204, and a group module (e.g., the group module 114 of FIG. 1) of the geo-spatial environment 100 to generate groups of user profiles 204. Each group is based on at least one category of preseeded data 214. The system further includes a display module (e.g., the display module 120 of FIG. 1) of the geo-spatial environment 100 to generate a display view of a three-dimensional map view embodied by a community network 200 (e.g., as illustrated in FIG. 8-11), at least a portion of the user profiles 204 represented at locations in the three-dimensional map view corresponding with the specific geographic locations 206 of the portion of the user profiles 204, and a communication module (e.g., the communication module 116 of FIG. 1) of the geo-spatial environment 100 to generate a communication via a communication mode (e.g., the communication mode 406 of FIG. 4) associated with at least one user profile 204 (e.g., a first user profile and/or a second user profile).

In yet another embodiment, a geo-spatial environment (e.g., the geo-spatial environment 100 of FIG. 1) includes a first instruction set to enable a community network (e.g., the community network 200 of FIG. 2), to include a preseeded data database (e.g., the preseeded data database 202 of FIG. 2) to include user profiles (e.g., the user profiles 204 of FIG. 2) and categories of preseeded data (e.g., the categories of preseeded data 214 of FIG. 2) and a map database (e.g., the map database 208 of FIG. 2) to include map data (e.g., the map data 122 of FIG. 1). The community network 200 is associated with specific geographic locations (e.g., the specific geographic location 206 of FIG. 2) identifiable in the map data. The geo-spatial environment 100 also includes a second instruction set integrated with the first instruction set to generate groups of user profiles 204, each group based on at least one category of preseeded data 214, and a third instruction set integrated with the first instruction set and the second instruction set to generate a communication associated with at least one user profile 204.

FIG. 1 is a system view of a geo-spatial environment 100 communicating with a map data 122 and users 102 through a network 104, according to one embodiment. Particularly, FIG. 1 illustrates the users 102, the network 104, a community network module 106, a map module 108, a data procurement module 110, a category module 112, a group module 114, a communication module 116, additional modules 118, a display module 120 and a map data 122, according to one embodiment.

The users 102 may be registered and/or unregistered users communicating in the geo-spatial environment 100. The network 104 may facilitate communication between the users 102 and the geo-spatial environment 100. The community network module 106 may include various user profiles (e.g., the user profiles 204 of FIG. 2) of the users 102 associated with specific geographic locations (e.g., the specific geographic location 206 of FIG. 2) in the geo-spatial environment 100. The map module 108 may generate a three-dimensional map view to visualize in a map (e.g., the three-dimensional map 812 of FIG. 8) the groups of user profiles 204 associated with the specific geographic location 206 in the geo-spatial environment 100, along with wiki profiles associated with users 102 in the neighborhood. The data procurement module 110 may procure preseeded data (e.g., may obtain and/or process the preseeded data from a public source, preexisting records, etc.) associated with the users 102 in the geo-spatial environment 100.

The category module 112 may provide categories (e.g., geographic region, age, age range, interest, religion, gender, occupation, ethnicity, location of a residence, location of a business, marital status, ownership status, language, mobility, income, life cycle, socioeconomic status, lifestyle, etc.) of the preseeded data (e.g., the preseeded data 212 of FIG. 2). The group module 114 may generate groups of user profiles 204, each group based on a category of preseeded data (e.g., the categories of preseeded data 214 of FIG. 2).

The communication module 116 may generate a communication via a communication mode (e.g., email, instant message, physical mail, audio, video, etc.) associated with a user profile 204. The additional modules 118 may generate different options for the users 102 associated with the user profiles 204 to communicate with each other. The display module 120 may generate a display view of the three-dimensional map embodied by the community network (e.g., the community network 200 of FIG. 2). The map data 122 may refer to data associated with specific geographic locations 206 of any number of users 102 associated with the user profiles 204.

In the example embodiment illustrated in FIG. 1, the users 102 communicate with the geo-spatial environment 100 through the network 104. The geo-spatial environment 100 consists of the community network module 106, the map module 108, the data procurement module 110, the category module 112, the group module 114, the communication module 116, and the additional modules 118 communicating with each other.

The preseeded data (e.g., the preseeded data 212 of FIG. 2) may be procured from a public source (e.g., using the data procurement module 110 of the geo-spatial environment 100). The category module 112 of the geo-spatial environment 100 may provide categories of the preseeded data (e.g., the categories of preseeded data 214 of FIG. 2). The community network module 106 of the geo-spatial environment 100 may include user profiles (e.g., the user profiles 204 of FIG. 2), each user profile 204 to include at least a portion of the preseeded data 212. The map module 108 of the geo-spatial environment (e.g., the geo-spatial environment 100 of FIG. 1) may include map data (e.g., the map data 122 of FIG. 1) of specific geographic locations (e.g., the specific geographic location 206 of FIG. 2) associated with each user profile 204.

The group module 114 of the geo-spatial environment 100 may generate groups of user profiles 204, each group based on at least one category of preseeded data 214. The communication module 116 of the geo-spatial environment 100 may generate a communication via the communication mode 406 associated with at least one user profile 204. The display module 120 of the geo-spatial environment 100 may generate a display view of the three-dimensional map view embodied by the community network 200 (e.g., the three-dimensional map view 812 of FIG. 8). At least a portion of the user profiles 204 may be represented at locations in the three-dimensional map view corresponding with the specific geographic locations 206 of the portion of the user profiles 204. The geo-spatial environment 100 may include a third instruction set integrated with a first instruction set and a second instruction set to generate a communication associated with the user profile 204.

FIG. 2 is an exploded view of the community network module 106 of FIG. 1, according to one embodiment. Particularly, FIG. 2 illustrates the map data 122, a community network 200, a preseeded data database 202, user profiles 204, a specific geographic location 206, a map database 208, geographic regions 210, preseeded data 212, and categories of preseeded data 214, according to one embodiment.

The community network 200 may be a network of people, places and/or businesses in the geo-spatial environment (e.g., the geo-spatial environment 100 of FIG. 1). The preseeded data database 202 may contain preseeded data associated with the user profiles 204 in the community network 200. The user profiles 204 may capture (e.g., store, record, track, etc.) information (e.g., containing age data, interest data, occupation data, etc.) associated with users 102 of the specific geographic location 206 in the geo-spatial environment 100. The specific geographic location 206 may refer to a geographical location (e.g., residence address, business location, etc.) of the users 102 associated with the user profiles 204. The map database 208 may contain maps of any area (e.g., region, spatial coordinates, etc.) of the users 102 associated with the user profile 204.

The geographic regions 210 may be regions selected from a group (e.g., consisting of a neighborhood associated with a street address, a city, a county, a state, a country, etc. in the community network 200). The preseeded data 212 may be publicly available data (e.g., location of a residence, ethnicity, interests, etc.) associated with the user profile 204. The categories of preseeded data 214 may categorize the preseeded data 212 associated with the user profile 204 based on types of information (e.g., geographic region, age, age range, interest, religion, gender, occupation, ethnicity, location of a residence, location of a business, marital status, ownership status, language, mobility, income, life cycle, socioeconomic status, and/or lifestyle, etc.).

In the example embodiment illustrated in FIG. 2, the community network module 106 includes the community network 200, which further includes the map data 122, the preseeded data database 202, the map database 208, and the preseeded data 212 communicating with each other. In addition, the preseeded data 212 includes user profiles 204, the specific geographic location 206 and categories of preseeded data 214, according to the example embodiment illustrated in FIG. 2.

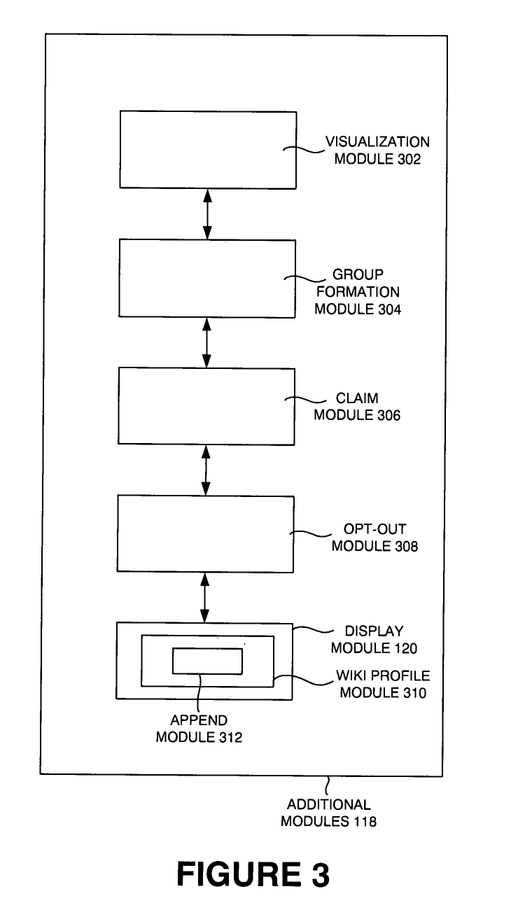

The community network 200 of the user profiles 204 may be generated based on the preseeded data 212 (e.g., each user profile 204 may be associated with a specific geographic location 206). Groups of user profiles 204 may be automatically generated within the community network 200 (e.g., using the group module 114 of FIG. 1 and/or the group formation module 304 of FIG. 3). For example, each group of user profiles 204 may be based on an at least one category of preseeded data 214 and/or at least a portion of the user profiles 204 may be represented at locations in a three-dimensional map view (e.g., the three-dimensional map view 812 illustrated in FIG. 8) corresponding with specific geographic locations 206.

A first instruction set (e.g., in the geo-spatial environment 100 of FIG. 1) may enable the community network 200 (e.g., the community network 200 may include the preseeded data database 202, the user profiles 204, the categories of preseeded data 214, and the map database 208 of FIG. 2 and the map data 122 of FIG. 1). The community network 200 may be associated with the specific geographic locations 206 identifiable in the map data 122. A second instruction set integrated with the first instruction set may generate groups of user profiles 204 (e.g., using the group module 114 of FIG. 1 and/or the group formation module 304 of FIG. 3), based on the categories of preseeded data 214.

FIG. 3 is an exploded view of the additional modules 118 of FIG. 1, according to one embodiment. Particularly, FIG. 3 illustrates the display module 120, a visualization module 302, a group formation module 304, a claim module 306, an opt-out module 308, a wiki profile module 310 and an append module 312, according to one embodiment.

The visualization module 302 may determine a geographic region (e.g., the geographic regions 210 of FIG. 2) to select a category (e.g., of preseeded data 212), and to automatically generate a group of user profiles 204 in which a geographic location of each user profile 204 of the group of user profiles 204 is associated with the geographic region 210. The group formation module 304 may enable formation of the group of user profiles 204, based on a category of preseeded data (e.g., the categories of preseeded data 214 of FIG. 2) in the geo-spatial environment 100. The claim module 306 may enable claiming of a user profile 204 in the geo-spatial environment 100. The opt-out module 308 may enable opting out of a claim (e.g., a claim to ownership) associated with a user profile 204 in the geo-spatial environment 100. The wiki profile module 310 may generate a wiki profile (e.g., the wiki profiles 806 of FIG. 8) associated with at least one representation of a user profile 204. The append module 312 may generate additional content associated with the wiki profiles 806.

In the example embodiment illustrated in FIG. 3, the additional modules 118 include the visualization module 302, the group formation module 304, the claim module 306, the opt-out module 308, the display module 120 which communicate with each other. In addition, the display module 120 includes the wiki profile module 310 and the append module 312.

The visualization module 302 of the geo-spatial environment 100 may determine a geographic region 210 that selects at least one category of preseeded data 214, and automatically generates (e.g., in a three-dimensional map display view) a group of user profiles 204 in which each specific geographic location 206 of each user profile 204 is associated with the geographic region 210, and/or and the category of preseeded data 214 is associated with (e.g., is referenced by) each user profile 204.

The group formation module 304 of the geo-spatial environment 100 may enable formation of a group of user profiles 204 based on at least one category of preseeded data 214 (e.g., a group may correspond to a category of preseeded data 214). The claim module 306 of the geo-spatial environment 100 may enable claiming of a user profile 204. The opt-out module 308 of the geo-spatial environment 100 may enable opting out of a claim associated with a user profile 204 (e.g., in the geo-spatial environment 100 of FIG. 1). The wiki profile module 310 may generate a wiki profile (e.g., a freely, openly and/or publically editable profile, the wiki profiles 806 of FIG. 8, etc.) associated with at least a representation (e.g., an avatar, a marker, an icon, etc.) of a user profile 204 (e.g., the representations of user profiles field 810 of FIG. 8). The append module 312 may generate content (e.g., additional information, summary of details, links, etc.) associated with the wiki profile 806.

FIG. 4 is a schematic representation of data communication, according to one embodiment. Particularly, FIG. 4 illustrates the map data 122, the preseeded data database 202, the user profiles 204, the map database 208, the preseeded data 212, the categories of preseeded data 214, a public source(s) of preseeded data 402, a geographic region 404 and a communication mode 406, according to one embodiment.

The public source(s) of preseeded data 402 may contain lists (e.g., directories) of commercial data, public records, etc. associated with the preseeded data (e.g., the preseeded data 212 of FIG. 2) of the user profiles (e.g., the user profiles 204 of FIG. 2) in the geo-spatial environment (e.g., the geo-spatial environment 100 of FIG. 1). The geographic region 404 may be a region selected from a group (e.g., including a neighborhood associated with a street address, a city, a county, a state, a country, etc.) in the geo-spatial environment 100. The communication mode 406 may enable (e.g., process) a communication associated with the first user profile 204 and the second user profile 204. In one example embodiment, the communication mode 406 may be selected from a group consisting of an email, an instant message, a physical mail, an audio communication, a video communication and/or a multimedia communication, etc.

In the example embodiment illustrated in FIG. 4, the preseeded data 212 received from the public source(s) of preseeded data 402 (e.g., commercial data lists, public records, etc.) may be stored in the preseeded data database 202. The preseeded data 212 may be stored in different categories in the preseeded data database 202 (e.g., categories of preseeded data 214). The information associated with the preseeded data 212 may be communicated to the users (e.g., the users 102 of FIG. 1) through the communication mode 406 (e.g., through email, instant message, physical mail, audio communication, video communication and/or multimedia communication, etc.).

A group of user profiles 204 may be automatically generated in a display view (e.g., by the group module 114 of FIG. 1), in which each a specific geographic location (e.g., the specific geographic location 206 of FIG. 2) of each user profile 204 of the group is associated with a first geographic region 404. A category of preseeded data 214 may be selected (e.g., using the community module 112 of FIG. 1), and/or the category of preseeded data 214 may be associated with each user profile 204 of the group.

The first geographic region 404 may be selected (e.g., through a communication with the group module 114 of FIG. 1) from a group (e.g., which includes a neighborhood associated with a street address, a city, a county, a state, and/or a country, etc.).

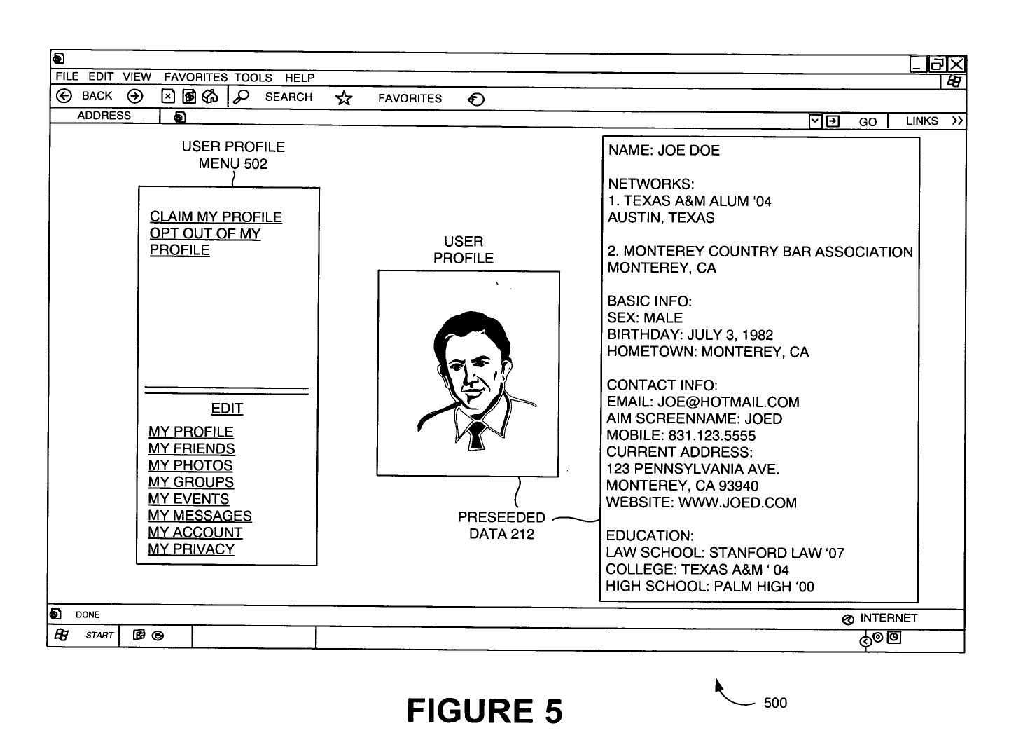

FIG. 5 is a user interface view 500 displaying preseeded data associated with a user profile (e.g., the user profile 204 of FIG. 2), according to one embodiment. Particularly, FIG. 5 illustrates the preseeded data 212 and a user profile menu option 502, according to one embodiment. The user profile menu option 502 may enable the users (e.g., the users 102 of FIG. 1) to claim their profiles (e.g., establish their ownership of the profiles) and/or opt-out from their profiles (e.g., dissociate themselves from a claim to their profiles).

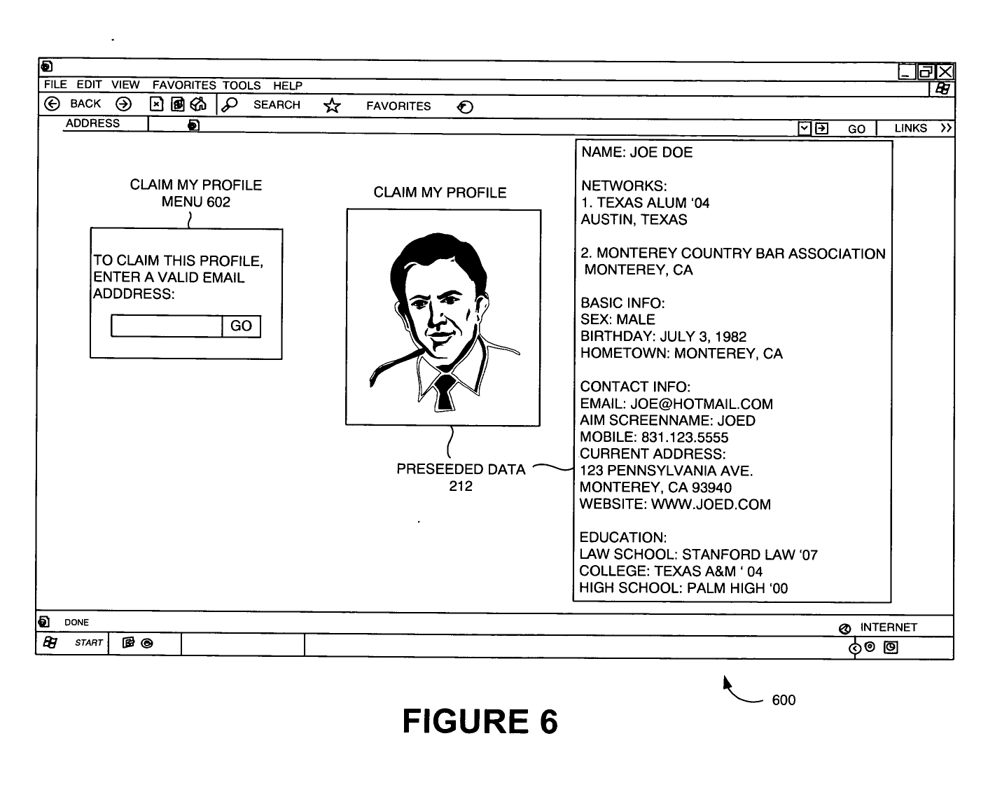

In the example embodiment illustrated in FIG. 5, the user interface view 500 may enable the user 102 to claim his/her profile and/or opt-out from his/her profile using the user profile menu option 502. In addition, the user profile menu option 502 may enable the user to edit his/her profile, invite friends (e.g., to become users 102 of the geo-spatial environment 100 of FIG. 1), upload and/or download photos, form and/or delete groups, create events, send and/or receive messages (e.g., communications, as illustrated in FIG. 4), and/or view his/her account information (e.g., the account may be linked to the user profile 204 associated with the user 102). The user 102 may be permitted to edit information of any wiki profile 806 until a particular wiki profile 806 is claimed (e.g., a user 102 may claim the wiki profile 806 and transform the wiki profile 806 into a user profile 204, as illustrated in FIG. 6).

FIG. 6 is a user interface view 600 of claiming the user profile (e.g., the user profile 204 of FIG. 2), according to one embodiment. Particularly, FIG. 6 illustrates the preseeded data 212 and a claim my profile menu option 602, according to one embodiment. The claim my profile menu option 602 may enable the user 102 (e.g., Joe Doe) to claim his/her user profile 204 (e.g., by entering a valid email address).

A registered user 102 (e.g., of the geo-spatial environment 100) may be enabled to claim a user profile 204. A claimant (e.g., a user 102 claiming a profile in the geo-spatial environment 100) may be enabled to segregate information of the claimed user profile 204 and an associated wiki profile (e.g., the wiki profiles 806 of FIG. 8) associated with a specific geographic location (e.g., the specific geographic location 206 of FIG. 2) of the claimed user profile 204.

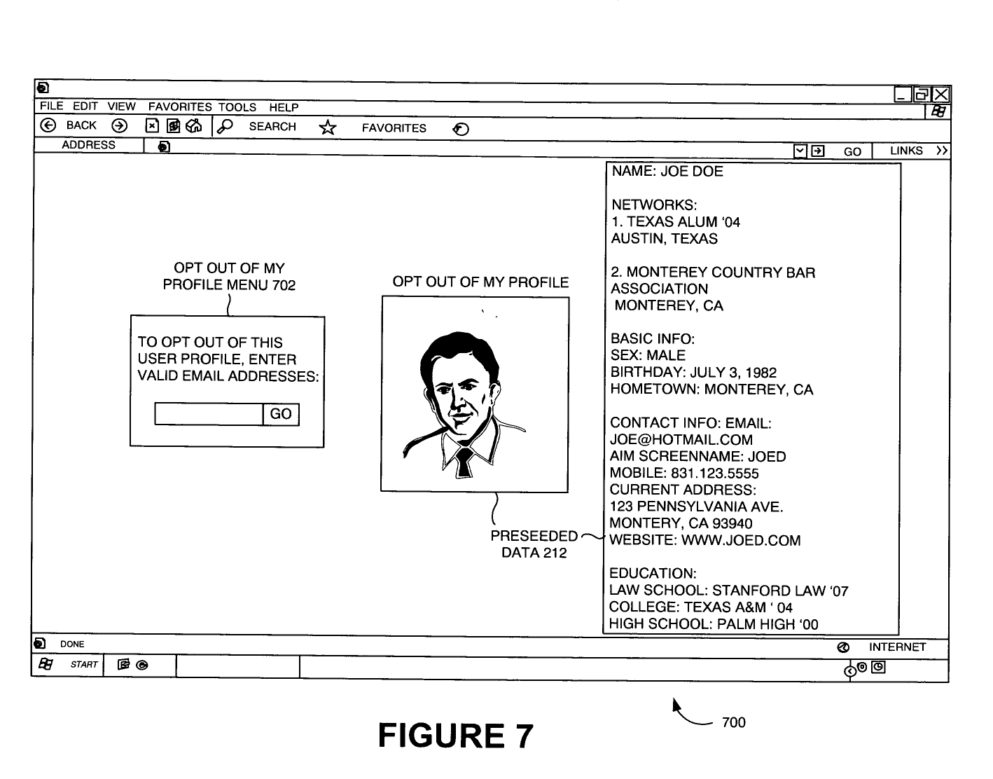

FIG. 7 is a user interface view 700 of opting out from the user profile (e.g., a claimed user profile 204 of FIG. 2), according to one embodiment. Particularly, FIG. 7 illustrates the preseeded data 212 and an opt-out of my profile menu option 702, according to one embodiment. The opt-out of my profile menu option 702 may enable the user (e.g., the users 102 of FIG. 1) to opt-out of the claim (e.g., a claim linking the user 102 with the user profile 204) associated with his/her user profile 204 (e.g., by entering a valid email address).

FIG. 8 is a user interface view 800 displaying groups associated with a user (e.g., the users 102 of the geo-spatial environment 100 of FIG. 1), according to one embodiment. Particularly, FIG. 8 illustrates a my groups menu option 802, a click on place or wiki to see neighbors interests and groups option 804, a wiki profiles 806, a content option 808, a representations of user profiles field 810 and a three-dimensional map option 812, according to one embodiment.

The my groups menu option 802 may enable the user 102 to view his/her groups in the geo-spatial environment. The click on place or wiki to see neighbors interests and groups option 804 may enable the user 102 to view neighbors interests and groups around his/her neighborhood in the three-dimensional map 812 (e.g., the neighborhood may be a geographic region 404 associated with the user profile 204 of the user 102 in the geo-spatial environment 100). The wiki profiles 806 may display profile information associated with users 102 of a particular group through the three-dimensional map 812. The content option 808 may reference information associated with the wiki profiles 806 of the users 102 in the neighborhood of the geo-spatial environment 100.

The representations of user profiles field 810 may display profiles (e.g., the user profiles 204 of FIG. 2) associated with the users 102, on the three-dimensional map 812 in which specific geographic locations (e.g., the specific geographic location 206 illustrated in FIG. 2) of each user profile 204 of the group corresponds with a location in the three-dimensional map 812. The three-dimensional map option 812 may enable the users 102 to view the representations of the user profiles 810 and their contents in the geo-spatial environment (e.g., the geo-spatial environment 100 of FIG. 1).

In the example embodiment illustrated in FIG. 8, the user interface view 800 may enable the user (e.g., the users 102 of FIG. 1) to search for neighborhood groups, list all neighborhood groups, list all groups, edit all groups and/or visualize groups through the my groups menu option 802. In addition, the my groups menu option 802 may enable the user 102 (e.g., Joe Doe) to search the group of the user profiles 204 based on the categories (e.g., democrats, golfers, etc.) and/or form a group. The three-dimensional map options 812 may enable the user 102 to view his/her wiki profiles 806, neighbors' interests and groups through the click on place or wiki to see neighbors interests and groups option 804.

The wiki profiles 806 associated with specific geographic locations (e.g., the specific geographic location 206 of FIG. 2) may be simultaneously generated in the map. A claimant (e.g., a user 102) may be enabled to control which portions of segregated information are viewable and determine which parties are permitted to view a particular portion of the segregated information (e.g., based on the user 102 claiming a profile in the geo-spatial environment 100). The geo-spatial environment 100 may include a fourth instruction set to display (e.g., in the three-dimensional map 812 of FIG. 8), the representation of each user profile 810 of the group of user profiles 204, in which the specific geographic location 206 of each user profile 204 of the group corresponds with a location in the three-dimensional map 812. The geo-spatial environment 100 may include a fifth instruction set to select at least one category of preseeded data 214 (e.g., using the category module 112 of FIG. 1) and display in the three-dimensional map 812 the representation of each user profile 810 in the group of user profiles 204 (e.g., in which the specific geographic location 206 of each user profile 204 of the group corresponds with a location in the three-dimensional map 812) and each user profile 204 is associated with the at least one category of preseeded data 214.

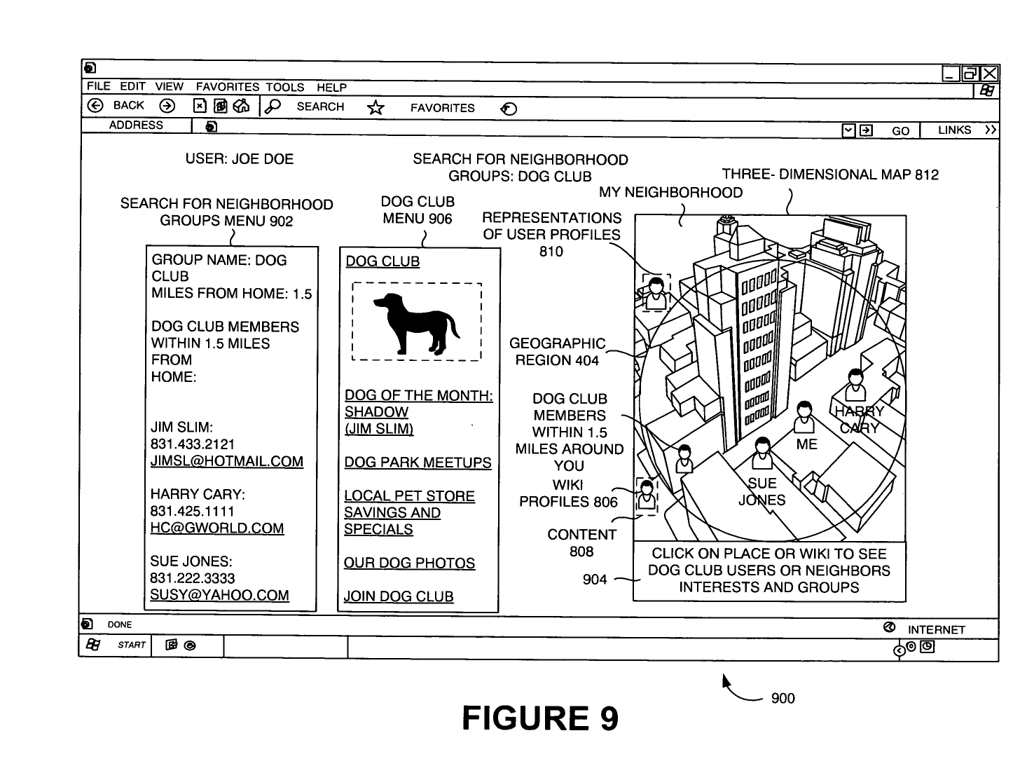

FIG. 9 is a user interface view 900 of searching for neighborhood groups in the geo-spatial environment (e.g., the geo-spatial environment 100 of FIG. 1), according to one embodiment. Particularly, FIG. 9 illustrates the geographic region 404, the wiki profile 806, the content option 808, the representations of user profiles field 810, the three-dimensional map option 812, an search for neighborhood groups menu option 902, a click on place or wiki to see dog club users or neighbors interests and groups option 904 and a dog club menu option 906, according to one embodiment. In the example embodiment illustrated in FIG. 9, a hypothetical neighborhood group is depicted as a dog club (e.g., users 102 of the group share an interest in dogs).

The search for neighborhood groups menu option 902 may enable users (e.g., the users 102 of FIG. 1) to search for neighborhood groups in the geo-spatial environment 100. The click on place or wiki to see dog club users or neighbors interests and groups option 904 may enable the users to view dog club users (e.g., users 102 who are part of a group of users having similar and/or shared interests, and/or who are associated with a particular category of preseeded data 214) or neighbors interests and groups around his/her neighborhood in the three-dimensional map 812. The dog club menu option 906 may enable the users to view a dog of the month (e.g., may allow users 102 of the group to showcase subjects of interest), dog park meetups (e.g., may allow users 102 of the group to coordinate meetings and/or events), local pet store savings and specials (e.g., may provide promotional content targeted at users 10 of the group and/or having an association with a particular category of preseeded data 214) and/or upload dog photos (e.g., may allow users 102 of the group to share content relevant to the collective interests of the group and/or express their own interests) and/or join the dog club (e.g., enable other users 102 to become part of the group in the geo-spatial environment 100).

In the example embodiment illustrated in FIG. 9, the user interface view 900 may enable the users to search for dog club members (e.g., within a radius of a specific location) through the search for neighborhood groups menu option 902. In addition, the user interface view 900 may enable the users 102 to view dog club users or neighbors' interests and groups, wiki profiles (e.g., the wiki profiles 806 of FIG. 8) associated with the users 102 in the neighborhood (e.g., through the three-dimensional map option 812 of FIG. 8).

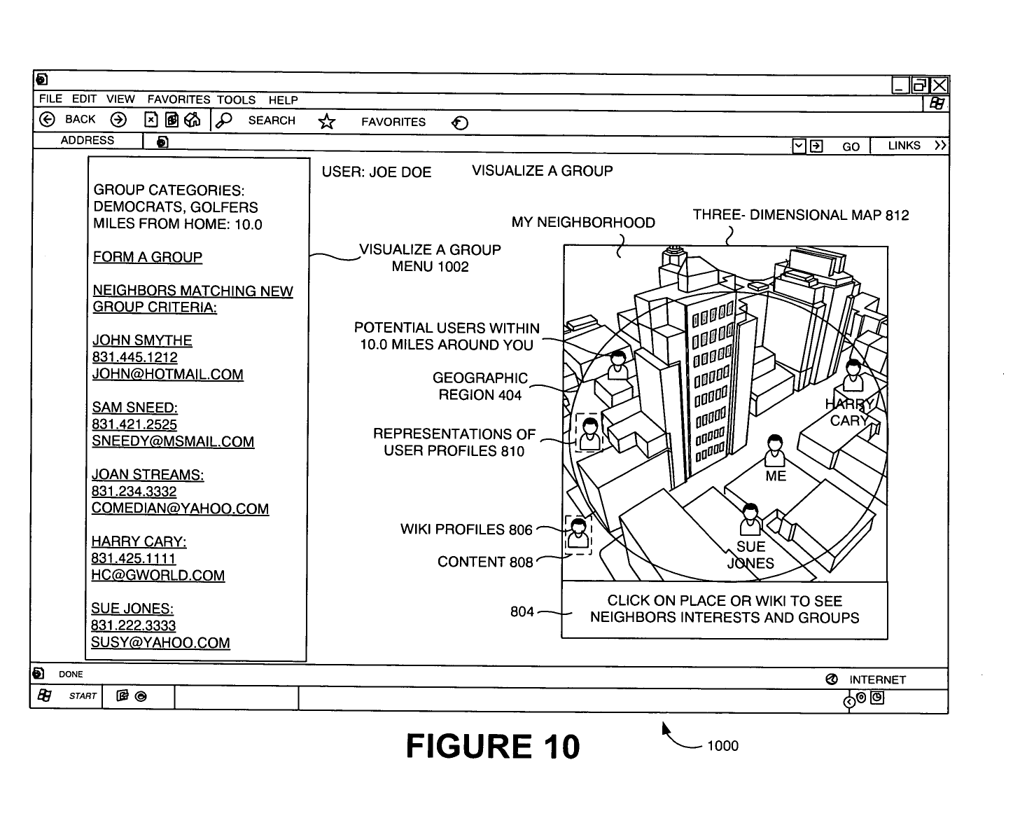

FIG. 10 is a user interface view 1000 of the visualization module of FIG. 3, according to one embodiment. Particularly, FIG. 10 illustrates the geographic region 404, the click on place or wiki to see neighbors interests and groups option 804, the wiki profiles 806, the content option 808, the representations of user profiles field 810, the three-dimensional map option 812 and a visualize a group menu option 1002, according to one embodiment.

The visualize a group menu option 1002 may enable the users 102 to view groups and/or to form a group (e.g., using a three-dimensional map and/or display view). In the example embodiment illustrated in FIG. 10, the user interface view 1000 may enable the user (e.g., the users 102 of FIG. 1) to view a group category (e.g., based on a category of preseeded data 214), form a group and/or visualize neighbors matching new group criteria. For example, Joe Doe may be associated with the “democrats” and “golfers” group categories. The user interface view 1000 may enable the user 102 to view potential users of the group (e.g., within a given radius of a location) in the three-dimensional map 812. For example, Joe Doe may be able to view users 102 in the neighborhood (e.g., within the region of the given radius) having some relevance (e.g., based on categories of preseeded data 214 associated with their user profiles 204) to the subject matter and/or interests of the group).

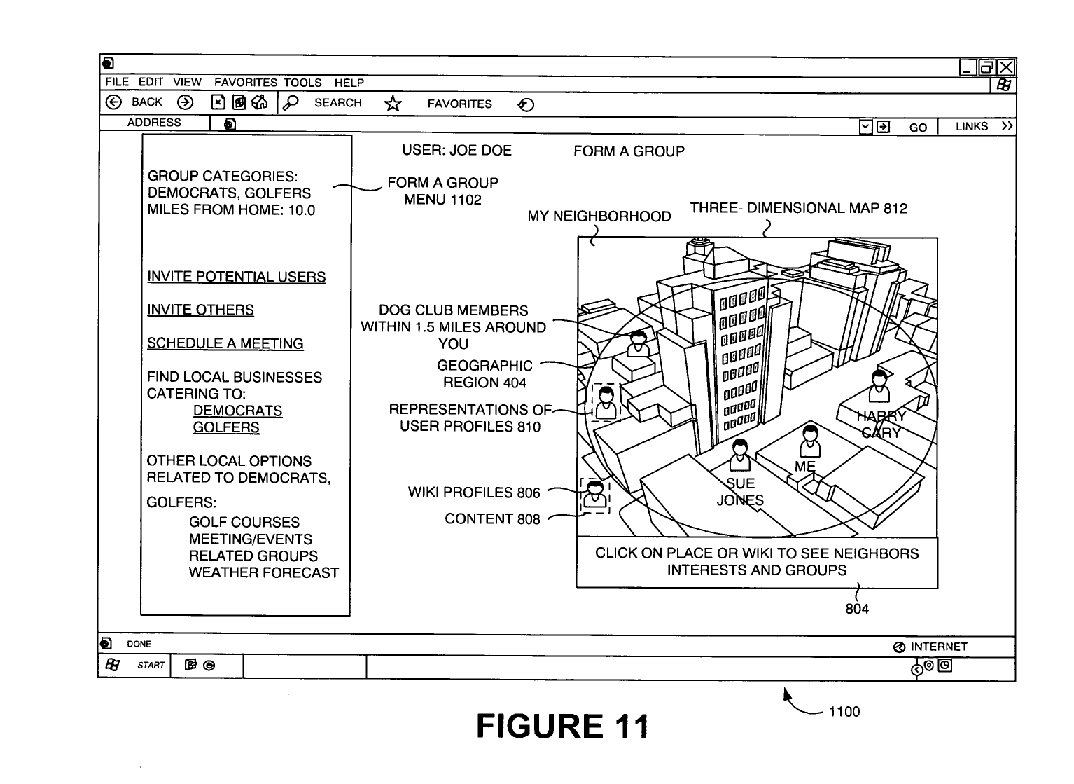

FIG. 11 is a user interface view 1100 of the group formation module 304 of FIG. 3, according to one embodiment. Particularly, FIG. 11 illustrates the geographic region 404, the click on place or wiki to see neighbors interests and groups option 804, the wiki profiles 806, the content option 808, the representations of user profiles field 810, the three-dimensional map option 812 and a form a group menu option 1102, according to one embodiment. The form a group menu option 1102 may enable users (e.g., the users 102 of FIG. 1) to form groups and invite potential users 102 and others to join the groups in the geo-spatial environment (e.g., the geo-spatial environment 100 of FIG. 1)

In the example embodiment illustrated in FIG. 11, the user interface view 1100 may enable the users 102 to form a group through the form the group menu option 1102. For example, Joe Doe may form a group and invite (e.g., using the communication module 116 of FIG. 1) potential users 102 and others to join the group. In addition, Joe Doe may schedule a meeting, find local businesses categories and/or other local options related to group categories in the geo-spatial environment 100. The user interface view 1100 may enable the user to view potential users (e.g., within 10 miles) of his/her neighborhood in the three-dimensional map 812. Formation of a group (e.g., using the group formation module 304 of FIG. 3) may be enabled based on at least one category of preseeded data (e.g., the categories of preseeded data 214 of FIG. 2).

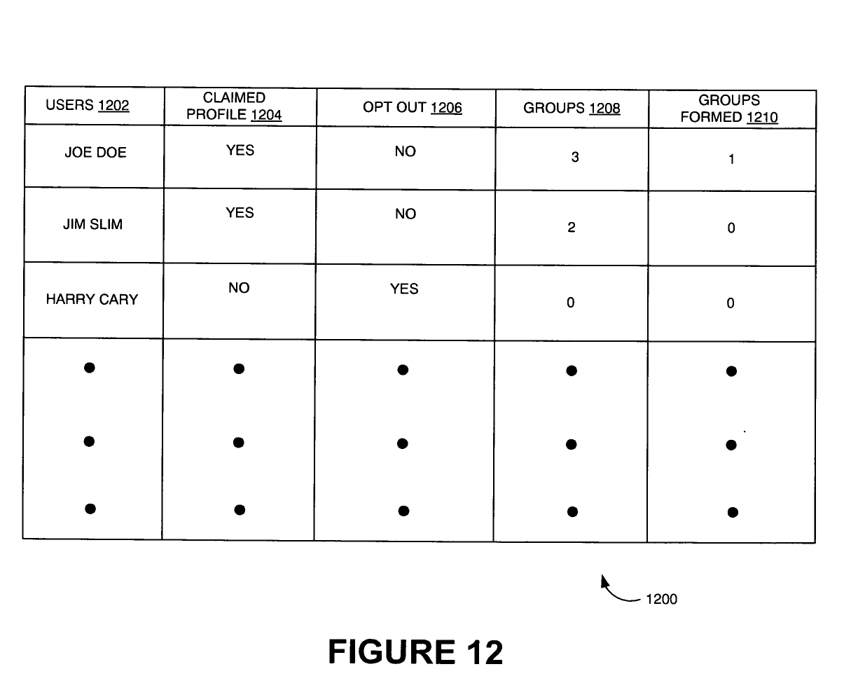

FIG. 12 is a table view 1200 showing details associated with a profile of a user (e.g., the users 102 of FIG. 1) in the geo-spatial environment (e.g., the geo-spatial environment 100 of FIG. 1), according to one embodiment. Particularly, FIG. 12 illustrates a users field 1202, a claimed profile field 1204, an opt-out field 1206, a groups field 1208, and a groups formed field 1210, according to one embodiment.

The users field 1202 may display an identifier (e.g., a name, a username, a unique key, etc.) referencing a user 102 associated with a user profile 204 in the geo-spatial environment 100. The claimed profile field 1204 may display the status (e.g., claimed, opt-out) of the profiles associated with the users 1202. The opt-out field 1206 may display the opt-out status of claims associated with user profiles (e.g., the user profiles 204 of FIG. 2) of the users 1202. The groups field 1208 may display numbers of groups the users 1202 are associated with. The groups formed field 1210 may display numbers of groups formed by the users 1202.

In the example embodiment illustrated in FIG. 12, the users field 1202 displays “Joe Doe” in the first row, “Jim Slim” in the second row and “Harry Cary” in the third row of the users field column 1202. The claimed profile field 1204 displays “Yes” in the first row, “Yes” in the second row and “No” in the third row of the claimed profile field column 1204. (e.g., Joe Doe and Jim Slims' profiles are claimed, but Harry Cary's profile is not claimed) The opt-out field 1206 displays “No” in the first row, “No” in the second row and “Yes” in the third row of the opt-out field column 1206 (e.g., Neither Joe Doe nor Jim Slim have opted out of their claimed profiles, Harry Cary has opted out of claiming his profile). The groups field 1208 displays “3” groups for Joe Doe in the first row, “2” groups for Jim Slim in the second row, and “0” groups for Harry Cary in the third row of the groups field column 1208. The groups formed field 1210 displays “1” in the first row for Joe Doe, “0” in the second row for Jim Slim and “0” for Harry Cary in the third row of the groups formed field column 1210.

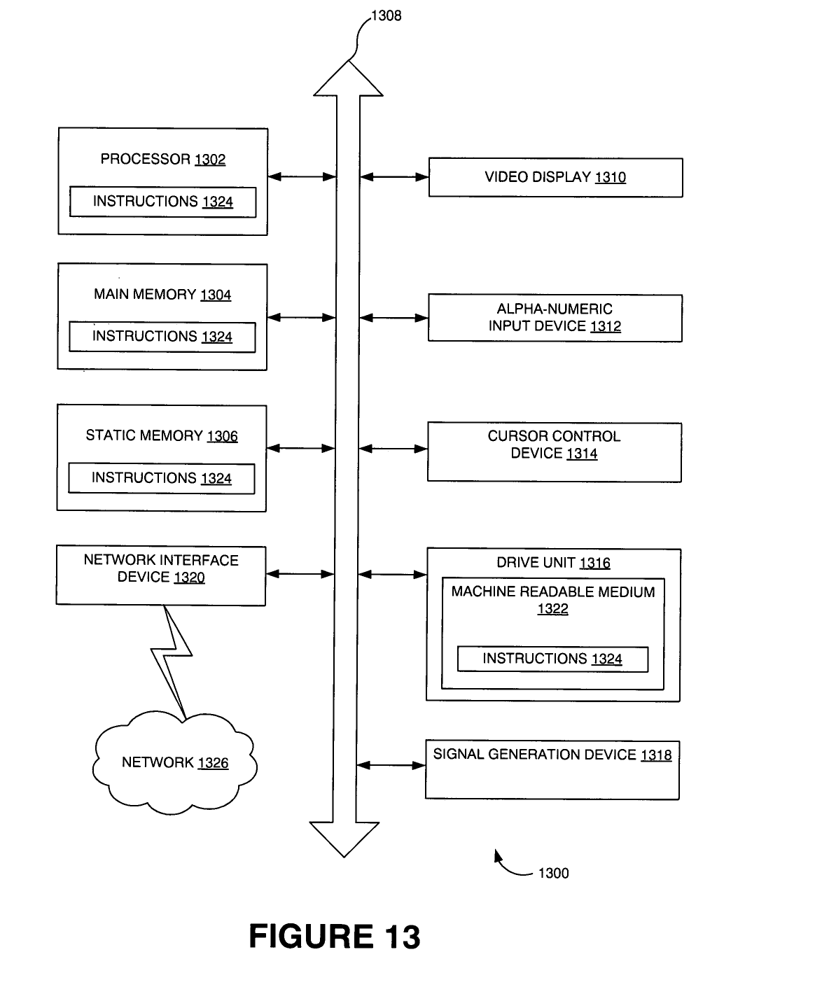

FIG. 13 is a diagrammatic system view 1300 of a data processing system in which any of the embodiments disclosed herein may be performed, according to one embodiment. Particularly, the system view 1300 of FIG. 13 illustrates a processor 1302, a main memory 1304, a static memory 1306, a bus 1308, a video display 1310, an alpha-numeric input device 1312, a cursor control device 1314, a drive unit 1316, a signal generation device 1318, a network interface device 1320, a machine readable medium 1322, instructions 1324, and a network 1326, according to one embodiment.

The diagrammatic system view 1300 may indicate a personal computer and/or a data processing system in which one or more operations disclosed herein may be performed. The processor 1302 may be a microprocessor, a state machine, an application-specific integrated circuit, a field programmable gate array, etc. (e.g., Intel® Pentium® processor). The main memory 1304 may be a dynamic random access memory and/or a primary memory of a computer system. The static memory 1306 may be a hard drive, a flash drive, and/or other memory information associated with the data processing system.

The bus 1308 may be an interconnection between various circuits and/or structures of the data processing system. The video display 1310 may provide graphical representation of information on the data processing system. The alpha-numeric input device 1312 may be a keypad, a keyboard and/or any other input device of text (e.g., a special device to aid the physically challenged). The cursor control device 1314 may be a pointing device such as a mouse.

The drive unit 1316 may be the hard drive, a storage system, and/or other longer term storage subsystem. The signal generation device 1318 may be a bios and/or a functional operating system of the data processing system. The network interface device 1320 may be a device that may perform interface functions such as code conversion, protocol conversion and/or buffering required for communication to and from a network. The machine readable medium 1322 may provide instructions on which any of the methods disclosed herein may be performed. The instructions 1324 may provide source code and/or data code to the processor 1302 to enable any one/or more operations disclosed herein.

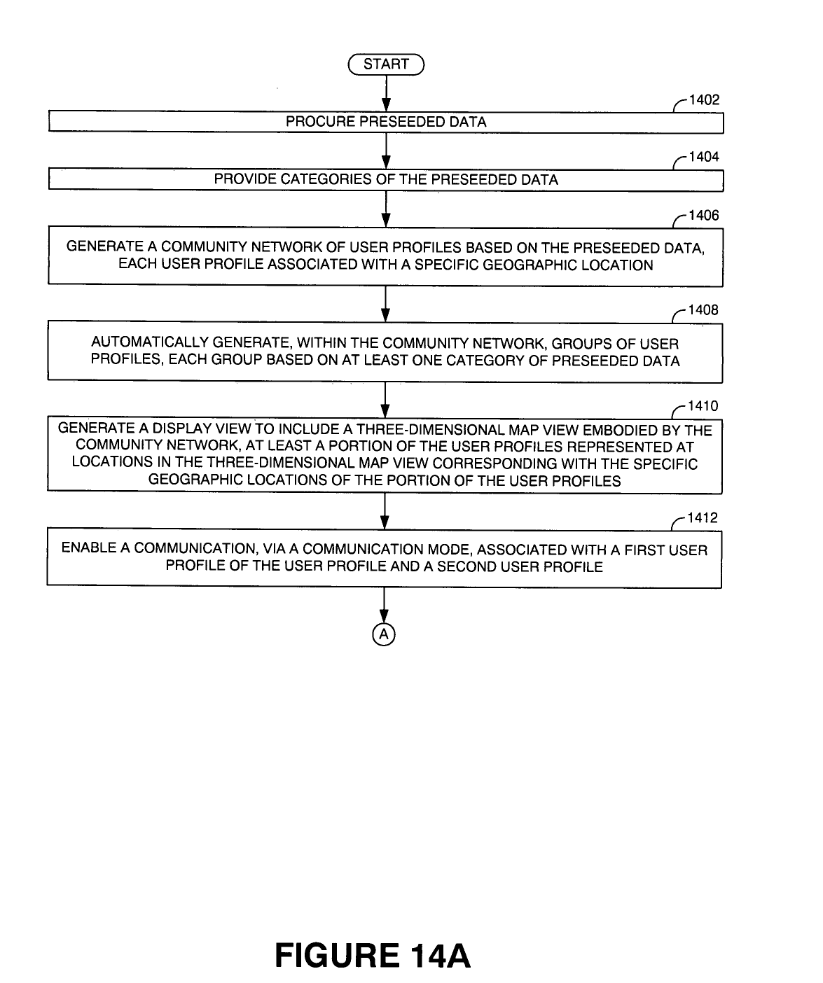

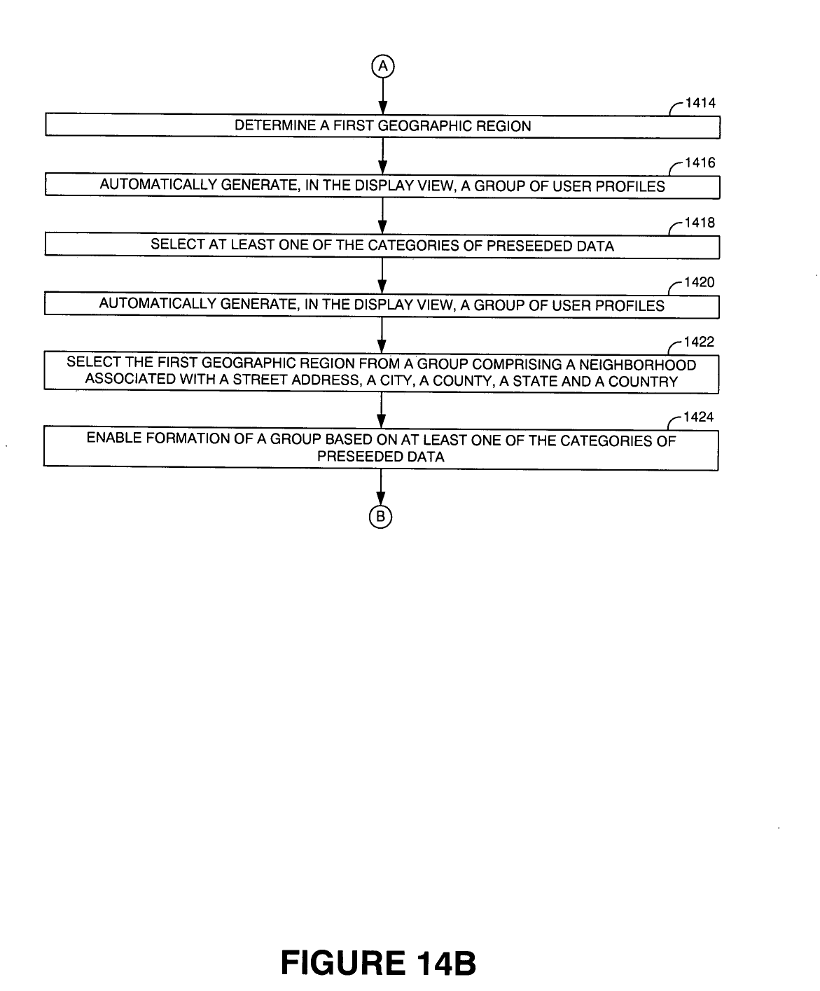

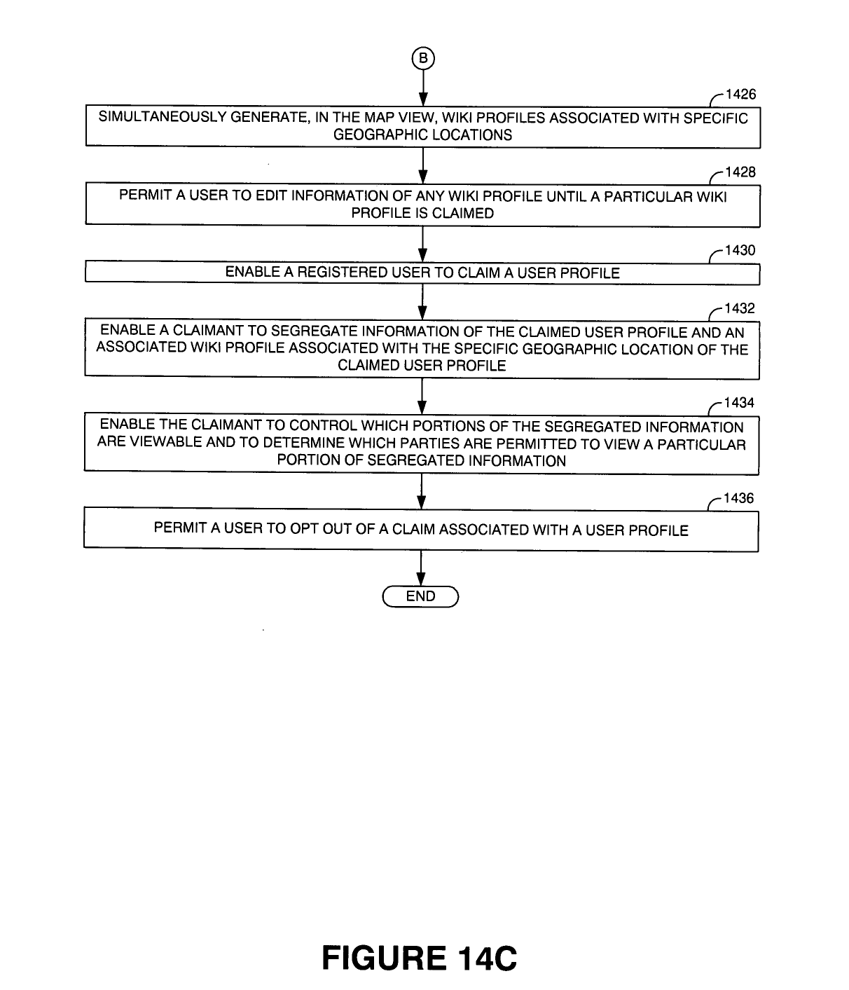

FIG. 14A is a process flow of forming a community network 200 based on preseeded data 212, according to one embodiment. In operation 1402, a preseeded data (e.g., the preseeded data 212 of FIG. 2) may be procured (e.g., from public sources, using the data procurement module 110 of FIG. 1). In operation 1404, categories of the preseeded data (e.g., the categories of preseeded data 214 of FIG. 2) may be provided. In operation 1406, a community network (e.g., the community network 200 of FIG. 2) of user profiles (e.g., the user profiles 204 of FIG. 2) may be generated based on the preseeded data 212. Each user profile 204 may be associated with a specific geographic location (e.g., the specific geographic location 206 of FIG. 2). In operation 1408, groups of user profiles 204 may be automatically generated within the community network 200, each group of the groups of user profiles 204 based on at least one category of the categories of preseeded data (e.g., the categories of preseeded data 214 of FIG. 2).

In operation 1410, a display view may be generated to include a three-dimensional map view (e.g., the three-dimensional map view 812 of FIG. 8) embodied by the community network 200, at least a portion of the user profiles 204 represented at locations in the three-dimensional map view corresponding with the specific geographic locations (e.g., the specific geographic location 206 of FIG. 2) of the portion of the user profiles 204. In operation 1412, a communication may be enabled via a communication mode (e.g., the communication mode 406 of FIG. 4), associated with a first user profile 204 and a second user profile 204.

FIG. 14B is a continuation of the process flow of FIG. 14A illustrating additional processes, according to one embodiment. In operation 1414, a first geographic region (e.g., the geographic regions of FIG. 2) may be determined. In operation 1416, a group of user profiles 204 may be automatically generated in the display view. In operation 1418, at least one of the categories of preseeded data 214 may be selected. In operation 1420, a group of user profiles 204 may be automatically generated in the display view. In operation 1422, the first geographic region 404 may be selected from a group comprising a neighborhood associated with a street address, a city, a county, a state, and a country (e.g., using the group module 114 of FIG. 1). In operation 1424, formation of a group may be enabled based on at least one of the categories of preseeded data 214 (e.g., using the group formation module 304 of FIG. 3).

FIG. 14C is a continuation of the process flow of FIG. 14B illustrating additional processes, according to one embodiment. In operation 1426, wiki profiles (e.g., the wiki profile 806 of FIG. 8) associated with specific geographic locations (e.g., the specific geographic location 206 of FIG. 2) may be simultaneously generated in the map (e.g., using the wiki profile module 310 of FIG. 3). In operation 1428, a user (e.g., the users 102 of FIG. 1) may be permitted to edit information of any wiki profile 806 until a particular wiki profile 806 is claimed. In operation 1430, a registered user 102 may be enabled to claim a user profile 204.

In operation 1432, a claimant may be enabled to segregate information of the claimed user profile 204 and an associated wiki profile 806 associated with the specific geographic location 206 of the claimed user profile 204. In operation 1434, the claimant may be enabled to control which portions of the segregated information are viewable and to determine which parties are permitted to view a particular portion of segregated information. In operation 1436, a user 102 may be permitted to opt-out of a claim associated with a user profile 204.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or Digital Signal Processor (DSP) circuitry). For example, the community network module 106, the map module 108, the data procurement module 110, the category module 112, the group module 114, the communication module 116, the additional modules 118, the display module 120, the visualization module 302, the group formation module 304, the claim module 306, the opt-out module 308, the wiki profile module 310, the append module 312 and other modules of FIGS. 1-14 may be enabled using a community circuit, a map circuit, a data procurement circuit, a category circuit, a group circuit, a display circuit, a communication circuit, additional circuits, a visualization circuit, a group formation circuit, a claim circuit, a opt-out circuit, a wiki profile circuit, a append circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
procuring preseeded data;
providing categories of the preseeded data;
generating a community network of user profiles based on the preseeded data, each user profile of the user profiles associated with a specific geographic location;
automatically generating, within the community network, groups of user profiles, each group of the groups of user profiles based on at least one category of the categories of the preseeded data;
generating a display view to include a three-dimensional map view embodied by the community network, at least a portion of the user profiles represented at locations in the three-dimensional map view corresponding with the specific geographic locations of the at least a portion of the user profiles; and
enabling a communication, via a communication mode, associated with a first user profile of the user profiles and a second user profile of the user profiles.

2. The method of claim 1, wherein procuring the preseeded data comprises:
procuring the preseeded data from a public source.

3. The method of claim 1, wherein providing categories of the preseeded data comprises:
providing categories of the preseeded data comprising: a geographic region, an age, an age range, an interest, a religion, a gender, an occupation, an ethnicity, a location of a residence, a location of a business, a marital status, an ownership status, a language, mobility, income, a life cycle, a socioeconomic status, and a lifestyle.

4. The method of claim 3, further comprising:
determining a first geographic region; and
automatically generating, in the display view, a group of user profiles wherein each specific geographic location of each user profile of the group of user profiles is associated with the first geographic region.

5. The method of claim 4, further comprising:
selecting at least one category of the categories of the preseeded data; and
automatically generating in the display view a group of user profiles, wherein each specific geographic location of the user profiles of the group of user profiles is associated with the first geographic region of the geographic regions and wherein each user profile of the user profiles is associated with the at least one category of the categories of the preseeded data.

6. The method of claim 4, further comprising:
selecting the first geographic region from a group comprising a neighborhood associated with a street address, a city, a county, a state, and a country.

7. The method of claim 1, further comprising:
enabling formation of a group based on at least one category of the categories of the preseeded data.

8. The method of claim 1, further comprising:
simultaneously generating, in the map, wiki profiles associated with specific geographic locations.

9. The method of claim 8, further comprising:
permitting a user to edit information of any wiki profile of the wiki profiles until a particular wiki profile is claimed;
enabling a registered user to claim a user profile of the user profiles;
enabling a claimant to segregate information of the claimed user profile and an associated wiki profile associated with the specific geographic location of the claimed user profile; and
enabling the claimant to control which portions of the segregated information are viewable and to determine which parties are permitted to view a particular portion of the segregated information.

10. The method of claim 1, further comprising:
permitting a user to opt-out of a claim associated with a user profile of the user profiles.

11. The method of claim 1, wherein the communication mode is selected from a group consisting essentially of an email, an instant message, a physical mail, an audio communication, a video communication, and a multimedia communication.

12. The method of claim 1 in a form of a machine-readable medium embodying a set of instructions that, when executed by a machine, causes the machine to perform the method of claim 1.

13. A system, comprising:
a geo-spatial environment;
a data procurement module of the geo-spatial environment to procure preseeded data;
a category module of the geo-spatial environment to provide categories of the preseeded data;
a community network module of the geo-spatial environment, to include user profiles, each user profile of the user profiles to include at least a portion of the preseeded data;
a map module of the geo-spatial environment to include map data of specific geographic locations associated with each user profile of the user profiles;
a group module of the geo-spatial environment to generate groups of user profiles, each group based on at least one category of the categories of the preseeded data;
a display module of the geo-spatial environment to generate a display view of the three-dimensional map view embodied by a community network, at least a portion of the user profiles represented at locations in the three-dimensional map view corresponding with the specific geographic locations of the at least a portion of the user profiles; and
a communication module of the geo-spatial environment to generate a communication, via a communication mode, associated with at least one user profile of the user profiles.

14. The system of claim 13, wherein the preseeded data is procured from a public source.

15. The system of claim 13, further comprising:
a visualization module of the geo-spatial environment to determine a geographic region, to select at least one category of the categories, and to automatically generate, in the display view, a group of user profiles, wherein each specific geographic location of each user profile of the group of user profiles is associated with the geographic region of the geographic regions and wherein each user profile of the user profiles is associated with the at least one category of the categories of the preseeded data.

16. The system of claim 15, wherein the geographic region is selected from a group comprising a neighborhood associated with a street address, a city, a county, a state, and a country.

17. The system of claim 13, further comprising:
a group formation module of the geo-spatial environment to enable formation of a group of user profiles based on at least one category of the categories of the preseeded data.

18. The system of claim 13, further comprising:
a claim module of the geo-spatial environment to enable claiming of a user profile of the user profiles.

19. The system of claim 13, further comprising:
an opt-out module of the geo-spatial environment to enable opting out of a claim associated with a user profile of the user profiles.

20. The system of claim 13, further comprising:
a wiki profile module to generate a wiki profile associated with at least one representation of a user profile.

21. The system of claim 20, further comprising:
an append module to generate, with the at least one wiki profile, content associated with the at least one wiki profile.

22. The system of claim 13, wherein the categories of the preseeded data include: a geographic range, an age, an age range, an interest, a religion, a gender, an occupation, an ethnicity, a location of a residence, a location of a business, a marital status, an ownership status, a language, mobility, income, a life cycle, a socioeconomic status, and a lifestyle.

23. The system of claim 13, wherein the communication mode includes: an email, an instant message, a physical mail, an audio communication, a video communication, and a multimedia communication.

24. A geo-spatial environment, comprising:
a first instruction set to enable a community network, to include a preseeded data database to include user profiles and categories of the preseeded data and a map database to include map data, in which the community network is associated with specific geographic locations identifiable in the map data;
a second instruction set integrated with the first instruction set to generate groups of user profiles, each group of the groups based on at least one category of the categories of the preseeded data; and
a third instruction set integrated with the first instruction set and the second instruction set to generate a communication associated with at least one user profile of the user profiles.

25. The geo-spatial environment of claim 24, further comprising:
a fourth instruction set to display, in a three-dimensional map, a representation of each user profile of a group of user profiles, wherein the specific geographic location of each user profile of the group of user profiles corresponds with a location in the three-dimensional map.

26. The geo-spatial environment of claim 24, further comprising:
a fifth instruction set to select at least one category of the preseeded data, and to display, in a three-dimensional map, a representation of each user profile in a group of user profiles, wherein the specific geographic location of each user profile of the group of user profiles corresponds with a location in the three-dimensional map and each user profile in the group of user profiles is associated with the at least one category of the preseeded data.
